(19) United States
(12) Patent Application Publication
(10) Pub. No.: US 2015/0006351 A1
(43) Pub. Date: Jan. 1, 2015

(54) REDEMPTION SYSTEM

(71) Applicant: Sylvia D. Dickerson-Wright, Las Vegas, NV (US)

(72) Inventor: Sylvia D. Dickerson-Wright, Las Vegas, NV (US)

(21) Appl. No.: 13/931,270

(22) Filed: Jun. 28, 2013

(51) Int. Cl. G06Q 40/04; G06Q 50/34

(52) U.S. Cl. CPC G06Q 40/04; G06Q 50/34
USPC 705/37

(57) ABSTRACT

A redemption system for redeeming a monetary instrument. The system includes a terminal that is hosted in proximity to a hosting facility and reads the monetary instrument. The monetary instrument is issued by at least one issuing facility. In this manner, the monetary instrument may be redeemed in a plurality of locations. The terminal is operable to read the monetary instrument, determine at least one corresponding item of merchandise and/or cash for which the monetary instrument may be redeemed, and dispense the corresponding at least one item of merchandise and/or cash. The hosting facility charges a service fee for redeeming the monetary instrument. The terminal includes a monetary instrument reception portion for receiving the monetary instrument and a monetary instrument reception portion that dispenses tickets and cash. A display portion and a data entry portion allow a use to view and select a desired redemption.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to redemption systems. More particularly, the invention relates to redeeming casino tickets from a network of casinos.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a casino is a facility which houses and accommodates certain types of gambling activities. Casinos are most commonly built near or combined with hotels, restaurants, retail shopping, cruise ships or other tourist attractions. Some casinos are also known for hosting live entertainment events, such as stand-up comedy, concerts, and sporting events.

Typically, casino patrons find entertainment value by gambling in the casino. The patron gambles by playing games of chance, in some cases with an element of skill, such as craps, roulette, baccarat, blackjack, and video poker. In games such as poker where players play against each other, the house takes a commission called the rake. Casinos sometimes give out complimentary items to the gamblers.

Often, casinos pay out winnings to the players in the form of a ticket. The ticket may be redeemed in a collection area of the casino for cash, gift items, or additional services from the casino.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective view of an exemplary redemption system and an exemplary monetary instrument, in accordance with an embodiment of the present invention;

FIGS. 2A and 2B illustrate detailed perspective views of exemplary terminals, in accordance with an embodiment of the present invention;

FIGS. 3A and 3B illustrate detailed perspective views of exemplary monetary instrument reception portions and monetary instrument dispensing portions, in accordance with an embodiment of the present invention;

FIG. 4 illustrates a detailed perspective view of an exemplary hosting facility, in accordance with an embodiment of the present invention;

FIG. 5 illustrates a system block diagram for an exemplary redemption system, in accordance with an embodiment of the present invention; and

FIG. 6 illustrates a typical computer system that, when appropriately configured or designed, can serve as an exemplary marketing method and system, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The present invention will now be described in detail with reference to embodiments thereof as illustrated in the accompanying drawings.

There are various types of monetary instrument redemption systems that may be provided by preferred embodiments of the present invention. In one embodiment of the present invention, the redemption system may provide a networked terminal hosted in proximity to a hosting facility that reads a monetary instrument issued by at least one issuing facility. In this manner, the monetary instrument may be redeemed in a plurality of locations. In some embodiments, the terminal may be operable to read the monetary instrument, determine at least one corresponding item of merchandise and/or cash for which the monetary instrument may be redeemed, and dispense the corresponding at least one item of merchandise and/or cash. In some embodiments, the hosting facility may charge a service fee, above and beyond all traditional services fees, for redeeming the monetary instrument.

In one embodiment of the present invention, the terminal may be networked with at least one issuing facility, whereby the networked terminal may identify and redeem a monetary instrument from any of the facilities. In some embodiments, the monetary instrument may include, without limitation, casino cash out ticket, encoded tickets, player loyalty instruments, and casino loyalty cards. The hosting facility and the issuing facility may include, without limitation, a casino, a gaming house, a hotel, a restaurant, a truck stop, and a ball room. In one embodiment, the terminal may redeem the monetary instrument for additional tickets, which may be utilized in the hosting facility or the issuing facility. In some embodiments, the terminal may network with a financial services facility to provide financial services, including, without limitation, automated teller network, credit card services, cash dispensing, and monetary transfers. In yet another embodiment, the terminal may break and dispense cash bills and coins.

In one embodiment of the present invention, the redemption system may be operable to network with a plurality of facilities for redeeming monetary instruments from the various facilities. The redemption system may include a terminal, a server, and a network. The terminal may position in proximity to the hosting facility, while operatively joining and communicating with at least one issuing facility. In some embodiments, the terminal may include a processor portion adapted to operate the terminal, and a data storage portion adapted to store information thereon. The data storage portion may include, without limitation, a database and management software that includes a data mining software portion and a user interface software portion therein. The data mining software portion may be adapted to query the database. The redemption system may be configured to allow the terminal and the data storage portion to communicate and to permit the transfer of information between the terminal and the at least one issuing facility. In this manner, monetary instruments issued from the at least one issuing facility and/or the hosting facility may be transacted in the terminal. Those skilled in the art, in light of the present teachings, will recognize that the terminal may be a relatively positioned terminal used by any of the facilities, whereby the facility containing the terminal is the hosting facility. In one alternative embodiment, the networked terminal may not be joined with any network, but rather redeem the monetary instruments from the at least one issuing facility by identifying preprinted codes on the monetary instrument and dispensing a correlating item of merchandise and/or cash.

In one embodiment of the present invention, the networked terminal may include at least one monetary instrument reception portion. The monetary instrument reception portion may include a slot for receiving a ticket and/or a credit card. For example, without limitation, one slot may receive tickets, while another slot may receive credit cards. In some embodiments, another slot may receive cash. However, in other embodiments, the monetary instrument reception portion may include an optical scanner, a magnetic reader, a card swipe device, a coin slot, a bill acceptor, and a fingerprint identification device. In one embodiment, a rotating cylinder may pull the monetary instrument into the terminal for processing. In some embodiments, the monetary instrument reception portion may include an identification portion that positions in proximity to the rotating cylinders for identifying the value of the monetary instrument. The identification portion may include a bar code reader for reading nonhuman readable codes on the monetary instrument. The processor portion may read the information on the monetary instrument and transmit the information to the at least one issuing facility. In one embodiment of the present invention, the terminal network may include a monetary instrument dispensing portion for dispensing the monetary instrument. The monetary instrument dispensing portion may be operatively joined with the monetary instrument reception portion. The monetary instrument dispensing portion may include dispensing cylinders that forcibly dispense the monetary instrument form the terminal. In one embodiment, the monetary instrument dispensing portion may not be utilized, and the redeemable value of the monetary instrument may be added to a credit card or a bank account, or a casino account. In some embodiments, the monetary instrument dispensing portion may include a printer portion for printing out tickets, whereby the tickets may be redeemed for items and/or services. The monetary instrument dispensing portion may also dispense cash, or break bills. In some embodiments, the networked terminal may include a display portion for displaying menu options. The display portion may include a touch screen having a menu. The menu may provide the various functional options for redeeming and manipulating the monetary instrument. The terminal may further include a data entry portion for selecting options to redeem the monetary instrument. In one embodiment, the data entry portion may integrate into the display portion in the case of a touch screen.

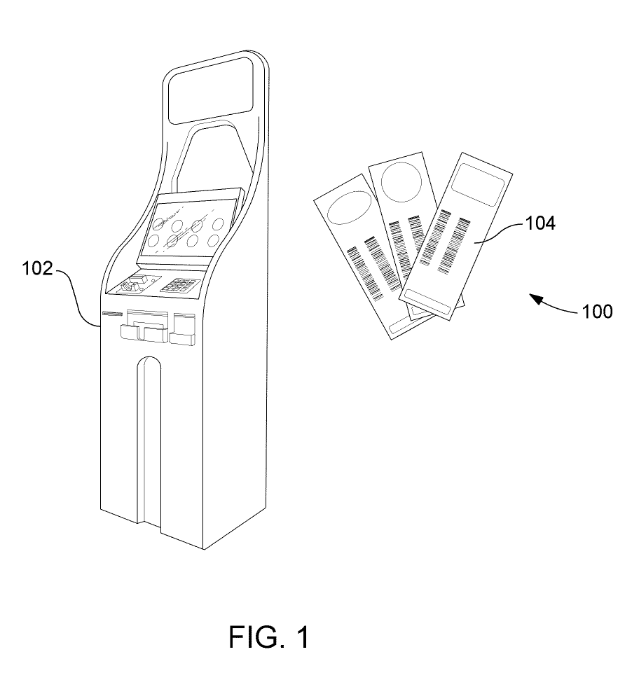

FIG. 1 illustrates a detailed perspective view of an exemplary redemption system and an exemplary monetary instrument, in accordance with an embodiment of the present invention. In the present invention, a redemption system 100 may provide a terminal 102 that is hosted in proximity to a hosting facility that reads a monetary instrument 104 issued by at least one issuing facility. In this manner, the monetary instrument may be redeemed in a plurality of locations. In some embodiments, the terminal may be operable to read the monetary instrument, determine at least one corresponding item of merchandise and/or cash for which the monetary instrument may be redeemed, and dispense the corresponding at least one item of merchandise and/or cash. In some embodiments, the hosting facility may charge a service fee, above and beyond all traditional services fees, for redeeming the monetary instrument.

In one embodiment of the present invention, the terminal may be networked with at least one issuing facility, whereby the networked terminal may identify and redeem a monetary instrument from any of the facilities. In some embodiments, the monetary instrument may include, without limitation, casino cash out ticket, encoded tickets, player loyalty checks, casino loyalty cards, and prepaid debit cards. The hosting facility and the issuing facility may include, without limitation, a casino, a gaming house, a hotel, a restaurant, a truck stop, and a ball room. In one embodiment, the terminal may redeem the monetary instrument for additional tickets, which may be utilized in the hosting facility or the issuing facility. In some embodiments, the terminal may network with a financial services facility to provide financial services, including, without limitation, automated teller network, credit card services, cash dispensing, and monetary transfers. In yet another embodiment, the terminal may break and dispense cash bills and coins.

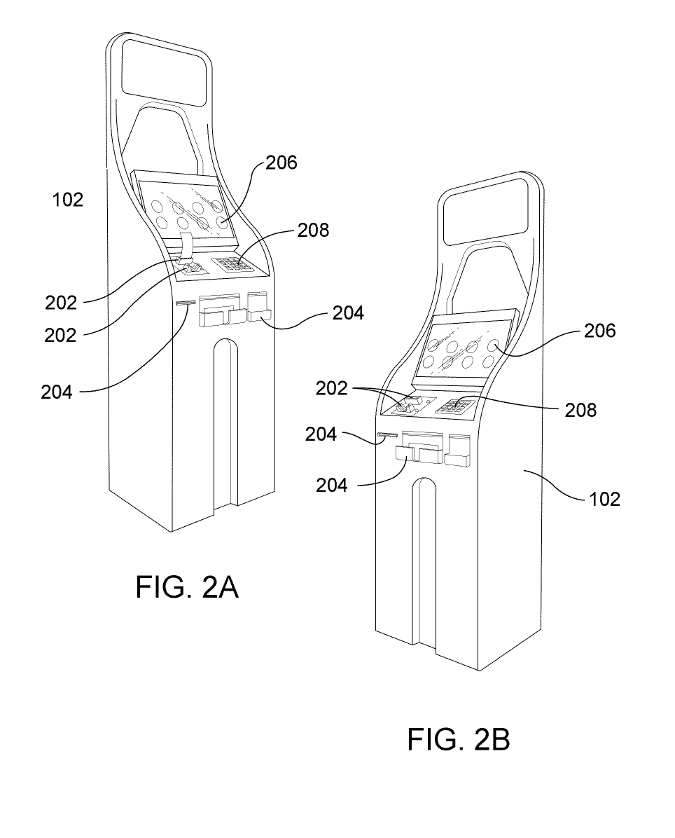

FIGS. 2A and 2B illustrate detailed perspective views of exemplary terminals, in accordance with an embodiment of the present invention. In the present invention, the redemption system may be operable to network with a plurality of facilities for redeeming monetary instruments from the various facilities. The network may be interconnected by communication channels that allow sharing of the monetary instrument information, and may include, without limitation, a local area network, a virtual network, an internetwork, an internet, and an intranet. The redemption system may include a terminal, a server, and a network. The terminal may position in proximity to the hosting facility, while operatively joining and communicating with at least one issuing facility. In some embodiments, the terminal may include a processor portion adapted to operate the terminal, and a data storage portion adapted to store information thereon. The data storage portion may include, without limitation, a database and management software that includes a data mining software portion and a user interface software portion therein. The data mining software portion may be adapted to query the database. The redemption system may be configured to allow the terminal and the data storage portion to communicate and to permit the transfer of information between the terminal and the at least one issuing facility. In this manner, monetary instruments issued from the at least one issuing facility and/or the hosting facility may be transacted in the terminal. Those skilled in the art, in light of the present teachings, will recognize that the terminal may be a relatively positioned terminal used by any of the facilities, whereby the facility containing the terminal is the hosting facility. In one alternative embodiment, the networked terminal may not be joined with any network, but rather redeem the monetary instruments from the at least one issuing facility by identifying preprinted codes on the monetary instrument and dispensing a correlating item of merchandise and/or cash. In one embodiment of the present invention, the networked terminal may include at least one monetary instrument reception portion 202 for receiving the monetary instrument. In one embodiment of the present invention, the terminal network may include a monetary instrument dispensing portion 204 for dispensing the monetary instrument. The monetary instrument dispensing portion may be operatively joined with the monetary instrument reception portion. In some embodiments, the networked terminal may include a display portion 206 for displaying menu options. The display portion may include, without limitation, a liquid crystal display, a plasma display, a digital screen, and an audio speaker. The display portion may include a touch screen having a menu. The menu may provide the various functional options for redeeming and manipulating the monetary instrument. The terminal may further include a data entry portion 208 for selecting options to redeem the monetary instrument. In one embodiment, the data entry portion may integrate into the display portion in the case of a touch screen. The data entry portion may include, without limitation, a keyboard, a touch screen, a light scanner, and a fingerprint device. One embodiment may include, without limitation, a touch-screen color monitor and keypad.

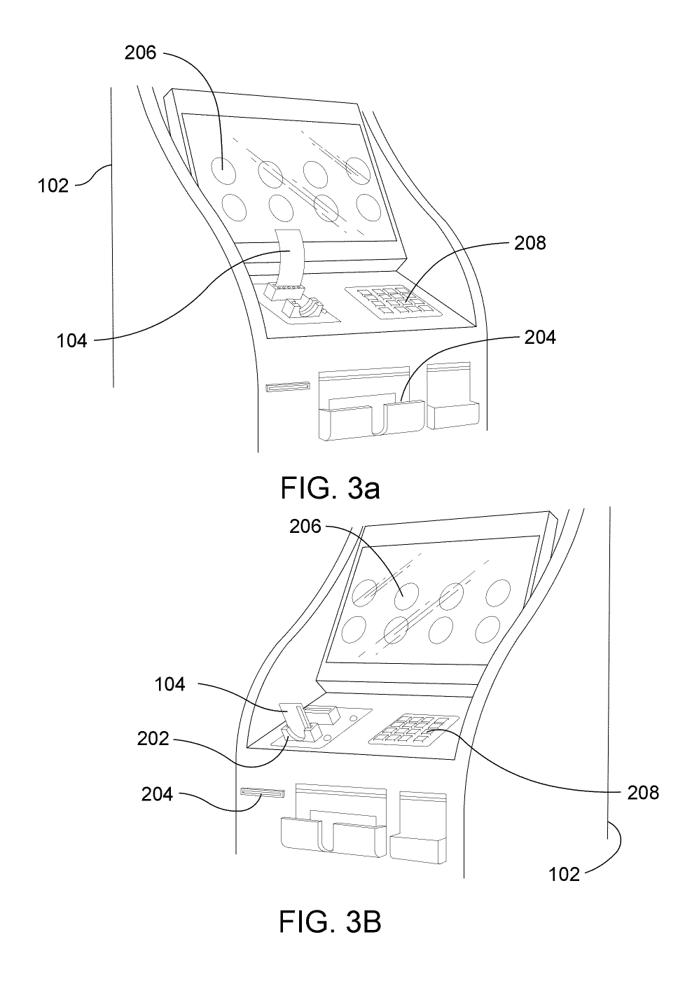

FIGS. 3A and 3B illustrate detailed perspective views of exemplary monetary instrument reception portions and monetary instrument dispensing portions, in accordance with an embodiment of the present invention. In the present invention, the networked terminal may include at least one monetary instrument reception portion. The monetary instrument reception portion may include a slot for receiving a ticket and/or a credit card. For example, without limitation, one slot may receive tickets, while another slot may receive credit cards. In some embodiments, another slot may receive cash. However, in other embodiments, the monetary instrument reception portion may include an optical scanner, a magnetic reader, a card swipe device, a coin slot, a bill acceptor, and a fingerprint identification device. In one embodiment, a rotating cylinder may pull the monetary instrument into the terminal for processing. In some embodiments, the monetary instrument reception portion may include an identification portion that positions in proximity to the rotating cylinders for identifying the value of the monetary instrument. The identification portion may include a bar code reader for reading nonhuman readable codes on the monetary instrument. The processor portion may read the information on the monetary instrument and transmit the information to the at least one issuing facility. In one embodiment of the present invention, the terminal network may include a monetary instrument dispensing portion for dispensing the monetary instrument. The monetary instrument dispensing portion may be operatively joined with the monetary instrument reception portion. The monetary instrument dispensing portion may include dispensing cylinders that forcibly dispense the monetary instrument form the terminal. In one embodiment, the monetary instrument dispensing portion may not be utilized, and the redeemable value of the monetary instrument may be added to a credit card or a bank account, or a casino account. In some embodiments, the monetary instrument dispensing portion may include a printer portion for printing out tickets, whereby the tickets may be redeemed for items and/or services. The monetary instrument dispensing portion may also dispense cash, or break bills. In one embodiment, the monetary instrument dispensing portion may include, without limitation, a reject bin to collect stuck bills without dispensing, three coin columns, hoppers for accessing the coin columns, and external basins for collecting coins.

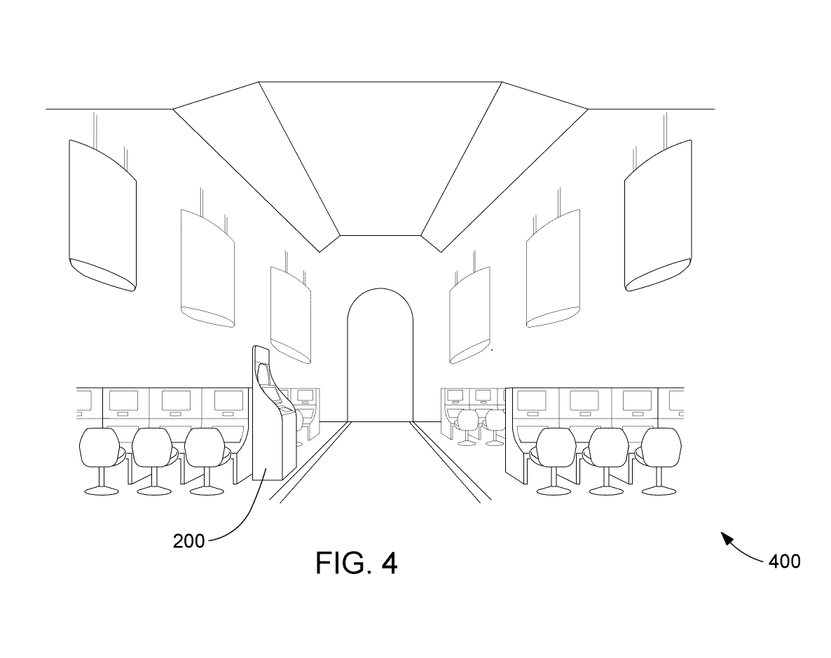

FIG. 4 illustrates a detailed perspective view of an exemplary hosting facility, in accordance with an embodiment of the present invention. In the present invention, a hosting facility 400 may include a casino that hosts a terminal for redeeming the monetary instrument. Those skilled in the art, in light of the present teachings, will recognize that winnings at a casino may be distributed in the form of a ticket, which may be redeemed in the same casino. The redemption system may allow the user to redeem the value of the ticket at a future time in a different casino or venue. The hosting facility and the at least one issuing facility may include, without limitation, a casino, a gaming house, a hotel, a restaurant, a truck stop, and a ball room. In one alternative embodiment, the redemption system may also be adapted to provide ancillary services, including, without limitation, hotel check-in/checkout, reservations and ticketing, and coupon printing, and may further be integrated with a financial services network to provide banking and credit card services. In yet another alternative embodiment, the terminal may be operatively joined with the internet, whereby a user may check on the value of the monetary instrument.

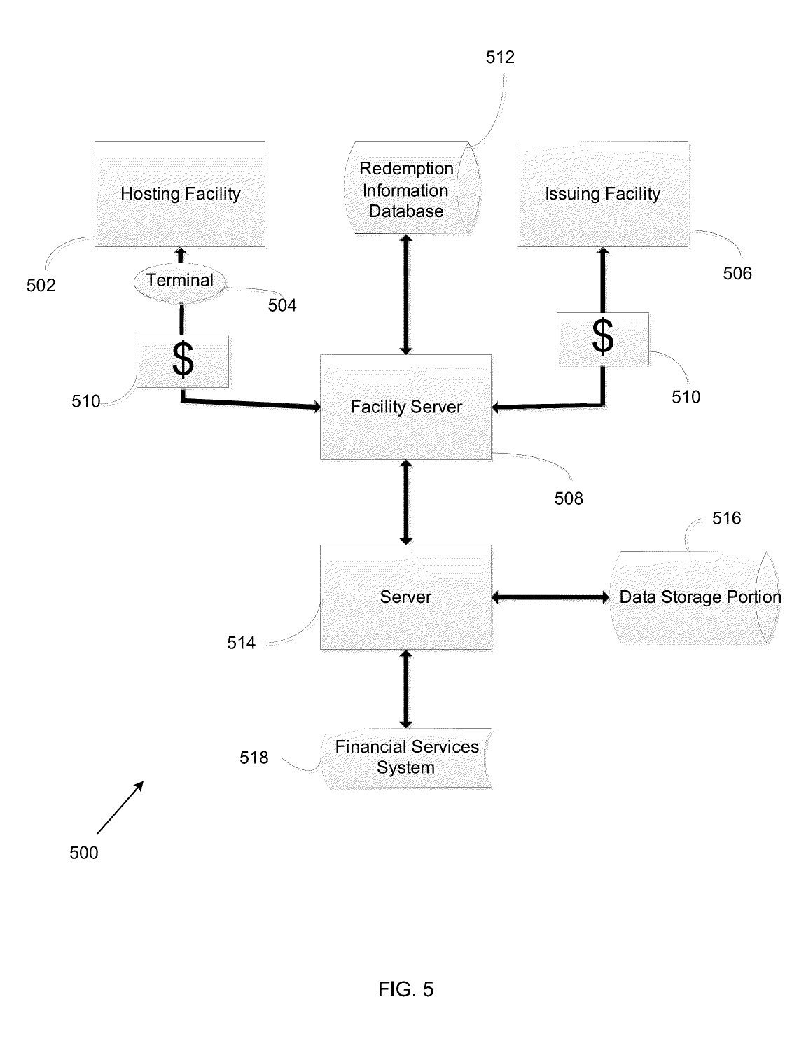

FIG. 5 illustrates a system block diagram for an exemplary redemption system, in accordance with an embodiment of the present invention. In media delivery system 500, hosting facility 502, terminal 504, and issuing facility 504 communicate with facility server 508. Terminal 504 may receive a monetary instrument 510 from issuing facility 504 for redeeming monetary instrument 510 for at least one item and/or cash. Server 508 may store monetary instrument information in redemption information database 512. Server 514 may query appropriate monetary instrument information to data storage portion 516. Facility Server 514 may transfer monetary instrument information to a financial services system 518.

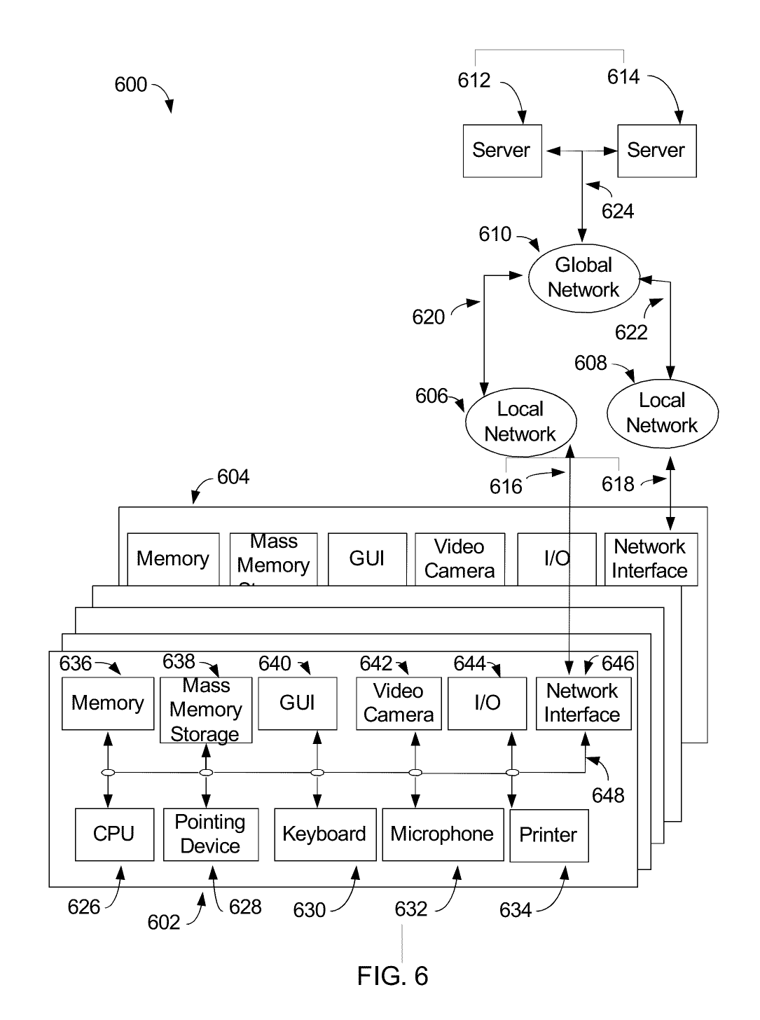

FIG. 6 illustrates a typical computer system that, when appropriately configured or designed, can serve as an exemplary marketing method and system, in accordance with an embodiment of the present invention. In the present invention, a communication system 600 includes a multiplicity of clients with a sampling of clients denoted as a client 602 and a client 604, a multiplicity of local networks with a sampling of networks denoted as a local network 606 and a local network 608, a global network 610 and a multiplicity of servers with a sampling of servers denoted as a server 612 and a server 614.

Client 602 may communicate bi-directionally with local network 606 via a communication channel 616. Client 604 may communicate bi-directionally with local network 608 via a communication channel 618. Local network 606 may communicate bi-directionally with global network 610 via a communication channel 620. Local network 608 may communicate bi-directionally with global network 610 via a communication channel 622. Global network 610 may communicate bi-directionally with server 612 and server 614 via a communication channel 624. Server 612 and server 614 may communicate bi-directionally with each other via communication channel 624. Furthermore, clients 602, 604, local networks 606, 608, global network 610 and servers 612, 614 may each communicate bi-directionally with each other.

In one embodiment, global network 610 may operate as the Internet. It will be understood by those skilled in the art that communication system 600 may take many different forms. Non-limiting examples of forms for communication system 600 include local area networks (LANs), wide area networks (WANs), wired telephone networks, wireless networks, or any other network supporting data communication between respective entities.

Clients 602 and 604 may take many different forms. Non-limiting examples of clients 602 and 604 include personal computers, personal digital assistants (PDAs), cellular phones and smartphones.

Client 602 includes a CPU 626, a pointing device 628, a keyboard 630, a microphone 632, a printer 634, a memory 636, a mass memory storage 638, a GUI 640, a video camera 642, an input/output interface 644 and a network interface 646.

CPU 626, pointing device 628, keyboard 630, microphone 632, printer 634, memory 636, mass memory storage 638, GUI 640, video camera 642, input/output interface 644 and network interface 646 may communicate in a unidirectional manner or a bi-directional manner with each other via a communication channel 648. Communication channel 648 may be configured as a single communication channel or a multiplicity of communication channels.

CPU 626 may be comprised of a single processor or multiple processors. CPU 626 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 636 is used typically to transfer data and instructions to CPU 626 in a bi-directional manner. Memory 636, as discussed previously, may include any suitable computer-readable media, intended for data storage, such as those described above excluding any wired or wireless transmissions unless specifically noted. Mass memory storage 638 may also be coupled bi-directionally to CPU 626 and provides additional data storage capacity and may include any of the computer-readable media described above. Mass memory storage 638 may be used to store programs, data and the like and is typically a secondary storage medium such as a hard disk. It will be appreciated that the information retained within mass memory storage 638, may, in appropriate cases, be incorporated in standard fashion as part of memory 636 as virtual memory.

CPU 626 may be coupled to GUI 640. GUI 640 enables a user to view the operation of computer operating system and software. CPU 626 may be coupled to pointing device 628. Non-limiting examples of pointing device 628 include computer mouse, trackball and touchpad. Pointing device 628 enables a user with the capability to maneuver a computer cursor about the viewing area of GUI 640 and select areas or features in the viewing area of GUI 640. CPU 626 may be coupled to keyboard 630. Keyboard 630 enables a user with the capability to input alphanumeric textual information to CPU 626. CPU 626 may be coupled to microphone 632. Microphone 632 enables audio produced by a user to be recorded, processed and communicated by CPU 626. CPU 626 may be connected to printer 634. Printer 634 enables a user with the capability to print information to a sheet of paper. CPU 626 may be connected to video camera 642. Video camera 642 enables video produced or captured by user to be recorded, processed and communicated by CPU 626.

CPU 626 may also be coupled to input/output interface 644 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 626 optionally may be coupled to network interface 646 which enables communication with an external device such as a database or a computer or telecommunications or internet network using an external connection shown generally as communication channel 616, which may be implemented as a hardwired or wireless communications link using suitable conventional technologies. With such a connection, CPU 626 might receive information from the network, or might output information to a network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing a redemption system that redeems monetary instruments from a network of facilities according to the present invention will be apparent to those skilled in the art. Various aspects of the invention have been described above by way of illustration, and the specific embodiments disclosed are not intended to limit the invention to the particular forms disclosed. The particular implementation of the redemption system that redeems monetary instruments from a network of facilities may vary depending upon the particular context or application. By way of example, and not limitation, the redemption system that redeems monetary instruments from a network of facilities described in the foregoing were principally directed to a terminal at a casino that redeems tickets for items and cash from a different casino implementations; however, similar techniques may instead be applied to hotel checkin/checkout, whereby the hotel can accept vouchers from competitor hotels, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A system comprising:
a terminal, said terminal being configured to redeem a monetary instrument for at least one item and/or cash, said terminal further being operable to charge a predetermined fee for redeeming said monetary instrument, said terminal being disposed to position in proximity to a hosting facility, said terminal being operable to network with at least one issuing facility, said at least one issuing facility being operable to issue said monetary instrument.

2. The system of claim 1, in which said hosting facility and/or said at least one issuing facility comprises a casino.

3. The system of claim 1, in which said monetary instrument comprises a casino ticket.

4. The system of claim 1, wherein said monetary instrument comprises a value of at least one item of merchandise and/or cash.

5. The system of claim 1, in which said terminal comprises a networked kiosk.

6. The system of claim 1, wherein said terminal is operable to network with at least one financial service facility.

7. The system of claim 1, wherein said terminal is operable to dispense cash and/or coins.

8. The system of claim 1, wherein said terminal is operable to receive at least one high value bill and dispense at least one small value bill having equivalent value to said at least one high value bill.

9. The system of claim 1, in which said terminal comprises a processor portion for operating said terminal.

10. The system of claim 1, in which said terminal comprises a data storage portion for storing and exchanging information with said at least one issuing facility.

11. The system of claim 1, in which said terminal comprises at least one monetary instrument reception portion.

12. The system of claim 11, in which said at least one monetary instrument reception portion comprises at least one slot configured to receive a ticket and/or a bill.

13. The system of claim 12, in which said at least one monetary instrument reception portion comprises an identification portion for reading said monetary instrument.

14. The system of claim 13, in which said identification portion comprises a bar code reader.

15. The system of claim 1, in which said terminal comprises at least one monetary instrument dispensing portion for dispensing said at least one monetary instrument.

16. The system of claim 15, in which said at least one monetary instrument dispensing portion comprises a printer portion for printing a ticket.

17. The system of claim 1, in which said terminal comprises a display portion for displaying menu options.

18. The system of claim 1, in which said terminal comprises a data entry portion for selecting a desired transaction.

19. A system comprising:
means for hosting a terminal in proximity to a hosting facility;
means for networking said terminal with at least one issuing facility;
means for issuing a monetary instrument from said issuing facility;
means for receiving said monetary instrument in said terminal; and
means for redeeming said monetary instrument.

20. A system consisting of:
a terminal, said terminal comprising a kiosk, said terminal being configured to redeem a monetary instrument for at least one item and/or cash, said monetary instrument comprising a casino ticket, said terminal further being operable to charge a predetermined fee for redeeming said monetary instrument, said terminal being disposed to position in proximity to a hosting facility, said hosting facility comprising a hosting casino, said terminal being operable to network with at least one issuing facility, said issuing facility comprising an issuing casino, said at least one issuing facility being operable to issue said monetary instrument, said terminal further being operable to accept at least one large value bill and return at least one small value bill, said terminal further being operable to dispense cash in correlation to a debit card, said terminal comprising a monetary instrument reception portion, said monetary instrument reception portion comprising a slot for receiving tickets and/or credit cards, said monetary instrument reception portion further comprising an identification portion for identifying said monetary instrument, said identification portion comprising a bar code reader, said terminal further comprising a monetary instrument dispensing portion, said monetary instrument dispensing portion comprising a printer portion for dispensing a redemption ticket, said terminal further comprising a display portion, said terminal further comprising a data entry portion, said terminal further being operable to collect a fee for redeeming the monetary instrument.
